(19) United States
(12) Patent Application Publication
(10) Pub. No.: US 2014/0143648 A1
(43) Pub. Date: May 22, 2014

(54) Bolt Shadow Workers

(71) Applicant: Vladimir Kolesnikov, Menlo Park, CA (US)

(72) Inventor: Vladimir Kolesnikov, Menlo Park, CA (US)

(21) Appl. No.: 13/679,035

(22) Filed: Nov. 16, 2012

(51) Int. Cl. G06F 17/00

(52) U.S. Cl. 715/234

(57) ABSTRACT

In one embodiment, a first thread of execution on a computing device fetches from a data store separate from the computing device content objects of a structured document to be rendered in a GUI of a software application on the computing device; processes the content objects to create one or more shadows; and sends the shadows to a second thread of execution on the computing device that is separate from the first thread of execution. The second thread of execution renders the structured document in the GUI of the software application on the computing device based at least in part on the shadows.

### TECHNICAL FIELD

This disclosure generally relates to graphical user interface.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may transmit over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

Particular embodiments may use multiple computing threads to display a web page. In particular embodiments, a worker thread may maintain a shadow (a collection of content objects) of the web page. The worker thread may fetch data from a remote server, combine it with locally cached data, create a shadow, then pass the shadow to a user-interface (UI) thread. The UI thread may then render the structured document based on the shadow. The worker thread may fetch and process data in the background, separately from the UI thread, thus improving overall web page loading and rendering performance.

### BRIEF DESCRIPTION OF THE DRAWINGS

FIG. 1 illustrates an example network environment associated with a social-networking system.

FIG. 2 illustrates an example social graph.

FIG. 3 illustrates an example method for displaying a structured document.

FIG. 4 illustrates an example computer system.

### DESCRIPTION OF EXAMPLE EMBODIMENTS

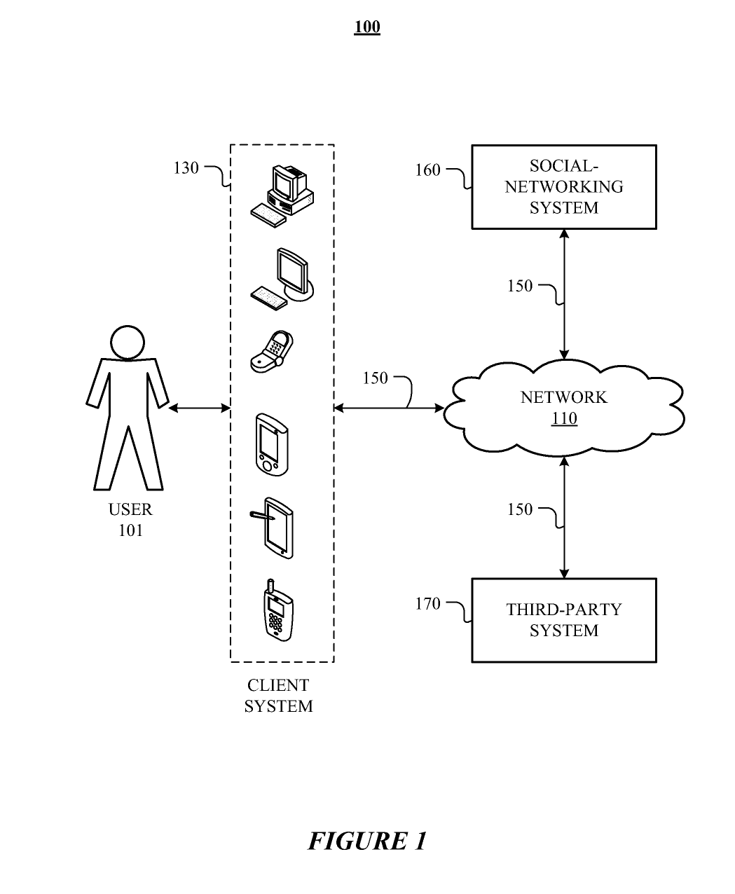

FIG. 1 illustrates an example network environment 100 associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and transmit social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server that allows users 101 to opt in or opt out of having their actions logged by social-networking system 160 or shared with other systems (e.g., third-party systems 170), such as, for example, by setting appropriate privacy settings. In particular embodiments, third-party system 170 may be a network-addressable computing system that can host websites or applications. Third-party system 170 may generate, store, receive, and transmit third-party system data, such as, for example and without limitation, web pages, text, images, video, audio, or applications. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable computing device, such as, for example, a personal computer, a laptop computer, a cellular telephone, a smartphone, or a tablet computer.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

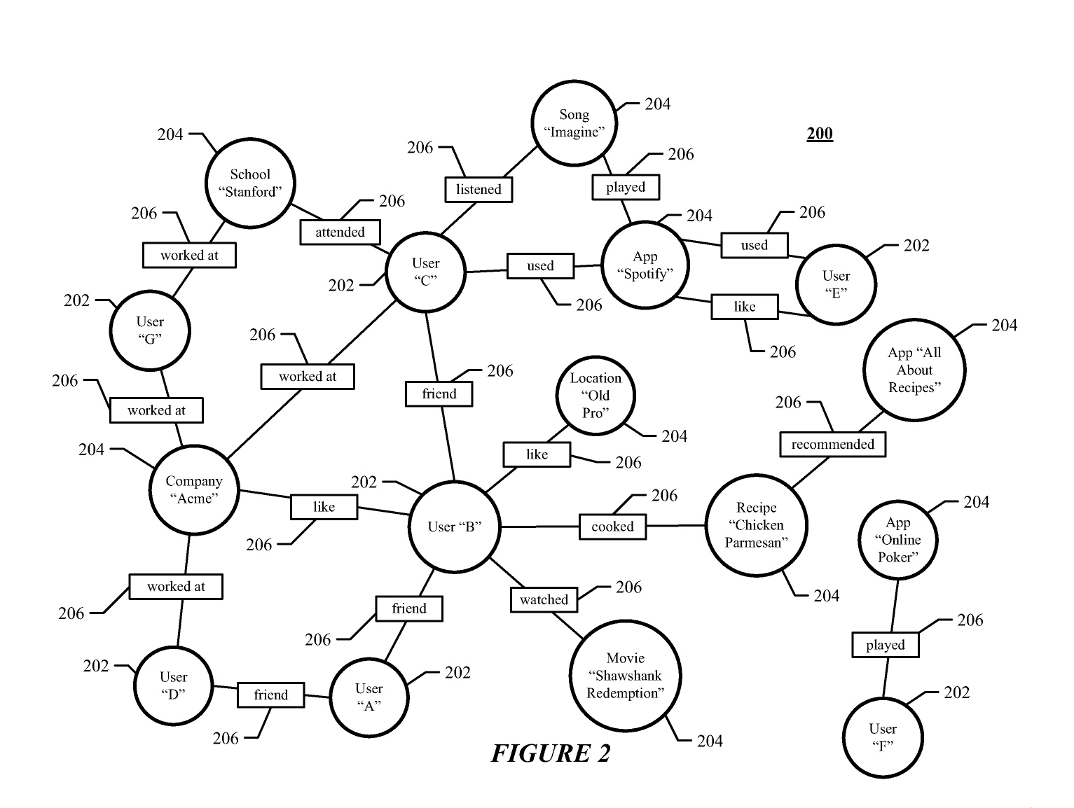

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 130 to transmit to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may transmit a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to transmit to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In addition, the degree of separation between any two nodes is defined as the minimum number of hops required to traverse the social graph from one node to the other. A degree of separation between two nodes can be considered a measure of relatedness between the users or the concepts represented by the two nodes in the social graph.

As described earlier, each time a user performs an activity or action (e.g., “like”) on an item or object supported by a social-networking system or a third-party system, the social-networking system may record the action. For example the social-networking system may automatically create in a social graph an edge (e.g., an “like” edge) between a user node corresponding to the user and a node corresponding to the item or object, and store the edge in a data store. Therefore, the social-networking system may record many actions performed by different users of the social-networking system at different times.

The social-networking system may provide to a user frequently update content based on recorded activities or actions that may be related to the user. In particular embodiments, the social-networking system may support a news-feed service. In particular embodiments, a news feed may comprise a data format including one or more news-feed stories. Each news-feed story may include content related to a specific subject matter or topic. In particular embodiments, the social-networking system may aggregate activities or actions related to a specific user action into a news-feed story. For example, a first user may post a photo to the social-networking system, while other users of the social-networking system may perform various activities or actions related to the photo. Other users may “like” the photo, post comments related to the photo, or tag one or more particular users to the photo. The social-networking system may aggregate activities related to the photo into a news-feed story comprising an image of the photo, a profile picture of the first user, a count of “likes” of the photo by other users, and one or more comments related to the photo. As for another example, a first user may checks in to a webpage (maintained by the social-networking system or a third-party system) corresponding to a place (e.g., a landmark, a restaurant, a department store). Other users of the social-networking system may “like” the check-in activity, or post comments related to the check-in activity. The social-networking system may aggregate activities related to the check-in activity into a news-feed story comprising a link and an image of the webpage, a profile picture of the first user, a count of “likes” of the check-in activity by other users, and one or more comments related to the check-in activity. The social-networking system may also aggregate into the news-feed story update to the webpage, or advertising related to the webpage (e.g., on-line coupons from a business related to the webpage). In particular embodiments, the social-networking may present a news feed including one or more news-feed stories to a viewing user. For example, an application (e.g., a web browser) hosted by a client device of the viewing user may retrieve a news feed from the social-networking system and display the news feed in the application's user interface. The application may display each news-feed story in the news feed in a respective frame (e.g., an HTML iFrame) in the application's user interface.

The social-networking system may aggregate activities or actions into news-feed stories based on social-graph information. For example, the social-networking system may aggregate for a viewing user a news feed including news-feed stories related to activities or actions performed by users who are within a specified degree of separation (e.g., within two degrees of separation) from the viewing user on the social graph. The social-networking system may aggregate activities or actions into news-feed stories based on privacy settings. For example, a user may specify which other users can access information of a particular activity performed by the user. The social-networking system may aggregate for a viewing user a news feed including news-feed stories related to activities accessible to the viewing user.

A structured document such as a web page may include, for example, page layout information (e.g., frames), scripts, page content such as text (e.g., ASCII or HTML), media data (e.g., images, video clips, or animations), and executable code objects (e.g., a game executable within a browser window or frame). Structured documents may be implemented with languages and technologies such as Hypertext Markup Language (HTML), Extensible Markup Language (XML), Extensible Hypertext Markup Language (XHTML), JavaScript, WebGL, Cascading Style Sheet (CSS) including CSS animations and transitions, and, frequently, Java. A structured document may itself include references to multiple structured documents and contents. For example, a web page may include one or more inline references by incorporating Uniform Resource Locations (URL's) or script code (e.g., JavaScript, PHP, or AJAX) that in response to a user event (e.g., a mouse click, a mouse hover-over), causes an application displaying the web page in a graphical user interface to dynamically retrieve content specified by an URL and the script code.

A layout engine (or web browser engine) is a software component or library for rendering structured documents in a graphical user interface. For example, Google's Chrome web browser and Apple's Safari web browser use WebKit software to render web pages. WebKit includes a layout engine WebCore and a JavaScript engine JavaScriptCore (for interpreting and executes JavaScript code). An application hosted by a computing device may utilize a layout engine to render structured documents by incorporating modules in the layout engine via an application programming interface (API) to the layout engine.

An application (e.g., a web browser) hosted by a computing device may display a structured document such as a web page by retrieving content of the structured document and rendering the structured document in a graphical user interface with a single computing thread executed by a processor of the computing device. On the other hand, the application (or a process of the application) may display the structured document more efficiently with multiple computing threads. Each thread may comprise a portion of instructions (for displaying the structured document) to be executed by at least one of the available processor of the computing device. Particular embodiments describe methods for displaying a structured document with a plurality of computing threads. Particular embodiments may comprise a worker thread and a user-interface (UI) thread. The worker thread may fetch from a remote server data of a structured document, combine it with locally cached data, and create a shadow of the structured document (e.g., a collection of content objects of the structured document). The work thread may then pass the shadow to the UI thread for rendering the structured document in a graphical user interface. By utilizing the worker thread (running separately from the UI thread) to fetch content of the structured document, particular embodiments may improve performance in loading and displaying the structured document.

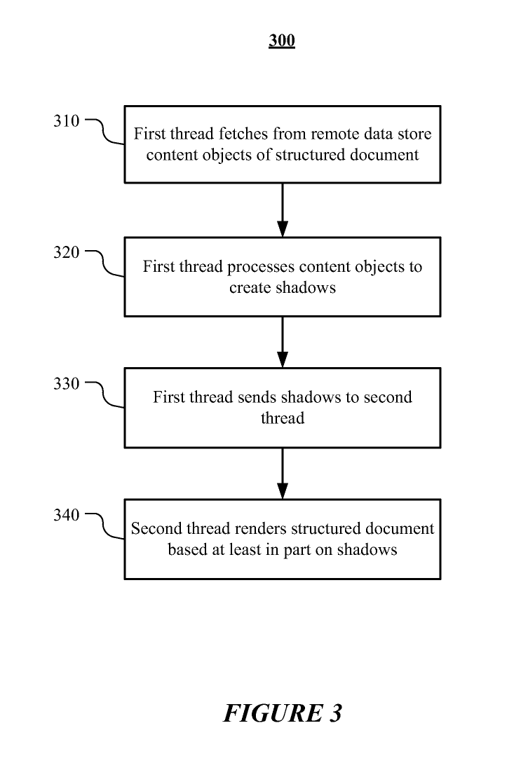

FIG. 3 illustrates an example method 300 for displaying a structured document. The example method 300 may implemented by a plurality of threads of execution on a computing device. The computing device may be a desktop computer, smartphone, tablet computer, laptop computer, or any suitable computing device with a display. The example method 300 may begin at step 310. In particular embodiments, at step 310, a first thread (a worker thread) of execution on the computing device may fetch from a data store separate from the computing device (i.e., a remote data store) one or more content objects of a structured document to be rendered in its graphical user interface (GUI) shown in the computing device's display. For example, the structured document may be a web page hosted by a website while the software application may be a web browser. The first thread may access the website and fetch content objects of the web page (e.g., text, media data, or executable code objects as described earlier). More particularly, the structured document may be a web page hosted by a social-networking system. A content object of the structured document may comprise a message, status update (a user's post to his or her profile page), or news-feed story. A content object may also comprise an advertisement including text, images, audio or video clips, or any suitable combinations of these, or in any suitable digital format. The first thread may access one or more data stores of the social-networking system and fetch content objects of the web page hosted by the social-networking system.

In particular embodiments, the first thread of execution may create one or more shadows of the structured document. A shadow may be a collection of content objects of structured document. In particular embodiments, a shadow may comprise a list of one or more content objects of the structured document. For example, a shadow may comprise all content objects of the structured document. For example, a shadow may comprise a list of content objects included in a particular area of the structured document (e.g., an iframe, a banner area, or a side-bar area). For example, a shadow may comprise a list of one or more news-feed stories and status updates of the structured document. For example, a shadow may comprise a list of one or more advertisements of the structured document. This disclosure contemplates any suitable shadow comprising any suitable combinations of content objects of the structured document.

In particular embodiments, at step 320, the first thread of execution may process one or more content objects fetched from the remote data store to create one or more shadows. For example, the first thread may fetch from the remote data store all content objects in the structured document to create a shadow. For another example, the first thread may fetch from the remote data store content objects corresponding to a particular area of the structured document to create a shadow. The first thread may update a shadow by fetching from the remote data store one or more content objects that may be new to the shadow. The first thread my create (or update) a shadow in response to a user event (e.g., a request to refresh the GUI, a mouse-over event on the GUI, a scrolling event on the GUI). Additionally, the first thread may create (or update) a shadow separately from a user event. For example, the first thread may create (or update) a shadow in response to a notification (or new content objects) pushed from the remote data store to the computing device. For another example, the first thread may create (or update) a shadow periodically (e.g., every 10 minutes).

In particular embodiments, the first thread may process a content object by combining the content object (fetched from the remote data store) with data cached locally on the computing device that corresponds to the content object. For example, the software application may display in the GUI a news-feed story comprising a text string (e.g., “Bob posted a photo”), an image (of the photo posted by Bob), a count of “likes”, and one or more comments by users of the social-networking system. The software application (or another process running on the computing device) may store (cache) the news-feed story's content locally at the computing device. Meanwhile, the first thread may create a shadow comprising the news-feed story including the text string, the image, the count of “likes”, and the user comments. In response to a user event (e.g., a mouse-over event), the first thread may fetch from the remote data store a new count of “likes” and one or more new user comments for the news-feed story. The first thread my update the existing shadow (or create a new shadow) comprising the news-feed story with the new count of “likes” and new user comments (combined with the text string, the image, and previously-displayed user comments that are already cached locally at the computing device). In some embodiments, the first thread may access the remote data store, determine changes of one or more content objects of a shadow, and update the shadow accordingly. For example, in the example of the shadow comprising the news-feed story described above, the first thread may access the remote data store, determine that a particular user comment (of the news-feed story) has been removed (or has been edited) in the data store, and update the shadow by deleting the particular user comment from the shadow (or updating the particular user comment with the one fetched from the remote data store).

In particular embodiments, the first thread may fetch from the remote data store one or more content objects included in a shadow based on object types or social-graph information. That is, the shadow may be a selectively updatable list of content objects of the structured document. For example, the first thread may fetch from the social-networking system all content objects in a shadow (e.g., messages, news-feed stories) excluding advertisements in the shadow. For example, for a user of the computing device, the first thread may fetch from the social-networking system content objects (in a shadow) that are associated with the user's first-degree connections in a social-graph of the social-networking system—e.g., a news-feed story related to a first-degree friend of the user, or an advertisement related to a company that the user “likes.” In one embodiment, a user of the computing device may configure particular object types or social-graph information that may be updated with the shadow (by the first thread or by the software application). For example, the user may configure (and save the configuration at the computing device) such that only messages in the structured document will be updated by the first thread (or the software application) with the shadow. For example, the user may configure such that only data related to the user's first-degree connections in the structured document will be updated by the first thread with the shadow.

In particular embodiments, at step 330, the first thread of execution may send one or more of the shadows to a second thread of execution (a UI thread) on the computing device, the second thread of execution being separate from the first thread of execution. In some embodiments, the first thread may send a complete shadow to the second thread. In other embodiments, the first thread may send to the second thread a portion of the shadow with content objects that are new to the second thread (e.g., content objects that are just updated by the first thread). That is, the second thread may keep “shadowing” new (or changes of) content objects of the structured document as fetched by the first thread. In particular embodiments, at step 340, the second thread of execution may render the structured document in the GUI of the software application on the computing device based at least in part on one or more of the shadows. For example, the second thread may update the structured document with content objects in the shadows received from the first thread and render the updated structured document in the GUI of the software application. By separating fetching and processing data of the structured document (i.e., the first thread) from rendering the structured document (i.e., the second thread), particular embodiments may improve overall loading and rendering performance in displaying the structured document.

The second thread of execution may render the structured document by creating a layered structure of the structured document, and creating a graphical presentation of the structured document (in the GUI) based on the layered structure. For example, the second thread may incorporate a layout engine and divide the structured document into one or more layers (e.g., based on HTML <div> or <iframe> tags). The second thread my parse a layer of the structured document into a render object tree or a tree of nodes in Document Object Model (DOM) representation, wherein each node of a tree of nodes may comprise text, an image object, other DOM object, or a pointer or root of another tree of nodes. The second thread may generate a raster image (i.e., a bitmap image) for each layer based on the render object tree and composite or combine raster images of the one or more layers into a single image as the graphical presentation of the structured document to be displayed in the GUI. The second thread may also create animation of the structured document by composting the raster images into a sequence of images.

Particular embodiments may utilize additional threads of execution to improve performance. In particular embodiments, the second thread of execution may comprise a plurality of threads of execution. For example, the second thread may comprise a parsing thread that is configured to parse the structured document and create a layered structure (e.g., a DOM tree) of the structured document. The second thread may also comprise a graphing thread that is configured to generate the raster images (for each layers of the layered structure) and create the graphical presentation of the structured document by compositing the raster images. Furthermore, one or more threads of the second thread of execution may be executed by a graphics processor of the computing device. A graphics processor is a specialized circuit for efficiently manipulating geometrical representation of computer graphics and generating images for output to a display of a computing device. An application (or a process of the application) running on a computing device may access a graphics processor of the computing device via an application programming interface (API) for the graphics processor. For example, the graphing thread described above may comprise a rastering thread executed by a main processor of the computing device that is configured to generate the raster images, and a compositing thread executed by a graphics processor of the computing device that is configured to composite the raster images.

Although creating and updating shadows (collections of content objects of a structured document) may be implemented by the thread of execution that fetches content objects from a remote server (i.e., the first thread or the worker thread as described earlier), particular embodiments contemplate any suitable process or thread that creates and updates shadows. In particular embodiments, a first thread of execution on the computing device (a worker thread) may fetch content objects of a structured document, while a second thread of execution on the computing device (a UI thread) may create and update one or more shadows based on the content objects fetched by the first thread and render the structured document based on the shadows. The first thread may fetch from a remote data store (or a local data store of the computing device) content objects of the structured document and send the content objects to the second thread. The second thread may create one or more shadows with the content objects sent from the first thread. For example, a shadow corresponding to a news-feed story may include a text string (e.g., a status update), a count of “likes”, and user comments to the status update. The second thread may render the structured document based on the shadows (i.e., the content objects of the structured document). In response to a user event (or a notification or new data pushed from the remote server), the first thread may fetch from the remote data store new content objects of the structured document (e.g., new user comments). The first thread may also fetch from the remote data store changes to the content objects in the existing shadows (e.g., a change or deletion of a user comment as stored in the remote data store). The first thread may send to the second thread the new content objects and the changes to the content objects in the existing shadows. That is, the second thread may keep “shadowing” new (or changes of) content objects of the structured document as fetched by the first thread. The second thread then may update the shadows based on the new content objects (and the changes) sent from the first thread, and render the structured document based on the updated shadows.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

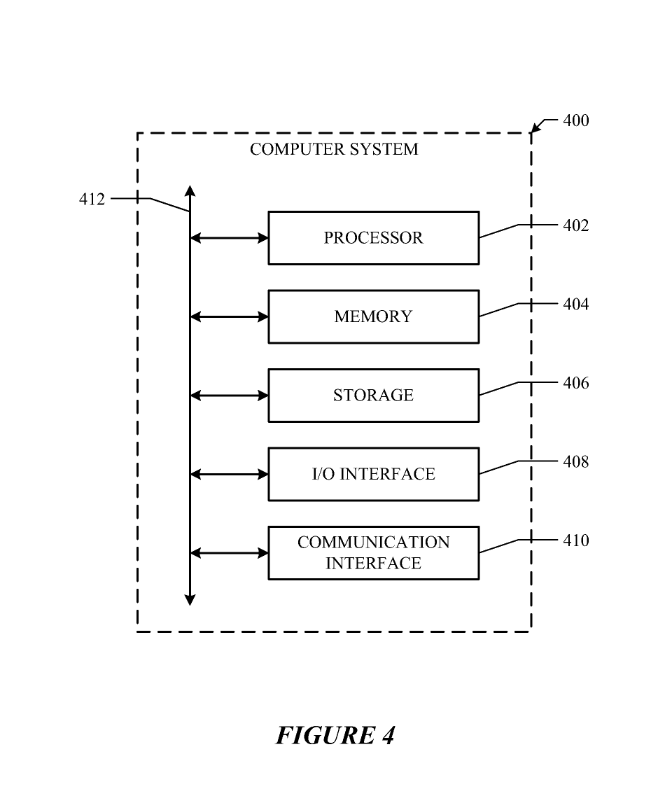

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a first thread of execution on a computing device, fetching from a data store separate from the computing device one or more content objects of a structured document to be rendered in a graphical user interface (GUI) of a software application on the computing device;
by the first thread of execution on the computing device, processing one or more of the content objects to create one or more shadows;
by the first thread of execution on the computing device, sending one or more of the shadows to a second thread of execution on the computing device, the second thread of execution being separate from the first thread of execution;
by the second thread of execution on the computing device, rendering the structured document in the GUI of the software application on the computing device based at least in part on one or more of the shadows.

2. The method of claim 1, wherein processing a content object to create a shadow comprises combining the content object with data cached locally on the computing device that corresponds to the content object.

3. The method of claim 1, wherein a content object comprises a message, status update, or news-feed story.

4. The method of claim 1, wherein the second thread of execution comprises a plurality of threads of execution, a first one of the threads of execution of the second thread of execution being configured to create a layered structure of the structured document, a second one of the threads of execution of the second thread of execution being configured to create a graphical presentation of the structured document based on the layered structure.

5. The method of claim 4, wherein the layered structure is a Document Object Model (DOM) tree.

6. The method of claim 4, wherein one or more of the threads of execution of the second thread of execution are executed at least in part by a graphics processor of the computing device.

7. The method of claim 1, wherein a shadow comprises a list of one or more content objects of the structured document.

8. The method of claim 1, wherein the software application is a web browser and the structured document is a web page.

9. One or more computer-readable non-transitory storage media embodying software that is operable when executed by a computing device to:
by a first thread of execution, fetch from a data store separate from the computing device one or more content objects of a structured document to be rendered in a graphical user interface (GUI) of a software application on the computing device;
by the first thread of execution, process one or more of the content objects to create one or more shadows;
by the first thread of execution, send one or more of the shadows to a second thread of execution, the second thread of execution being separate from the first thread of execution;
by the second thread of execution, render the structured document in the GUI of the software application on the computing device based at least in part on one or more of the shadows.

10. The media of claim 9, wherein processing a content object to create a shadow comprises combining the content object with data cached locally on the computing device that corresponds to the content object.

11. The media of claim 9, wherein a content object comprises a message, status update, or news-feed story.

12. The media of claim 9, wherein the second thread of execution comprises a plurality of threads of execution, a first one of the threads of execution of the second thread of execution being configured to create a layered structure of the structured document, a second one of the threads of execution of the second thread of execution being configured to create a graphical presentation of the structured document based on the layered structure.

13. The media of claim 12, wherein the layered structure is a Document Object Model (DOM) tree.

14. The media of claim 12, wherein one or more of the threads of execution of the second thread of execution are executed at least in part by a graphics processor of the computing device.

15. The media of claim 9, wherein a shadow comprises a list of one or more content objects of the structured document.

16. The media of claim 9, wherein the software application is a web browser and the structured document is a web page.

17. A computing device comprising:
one or more processors; and
a memory coupled to the processors comprising instructions executable by the processors, the processors being operable when executing the instructions to:
by a first thread of execution, fetch from a data store separate from the computing device one or more content objects of a structured document to be rendered in a graphical user interface (GUI) of a software application on the computing device;
by the first thread of execution, process one or more of the content objects to create one or more shadows;
by the first thread of execution, send one or more of the shadows to a second thread of execution, the second thread of execution being separate from the first thread of execution;
by the second thread of execution, render the structured document in the GUI of the software application on the computing device based at least in part on one or more of the shadows.

18. The computing device of claim 17, wherein processing a content object to create a shadow comprises combining the content object with data cached locally on the computing device that corresponds to the content object.

19. The computing device of claim 17, wherein a content object comprises a message, status update, or news-feed story.

20. The computing device of claim 17, wherein the second thread of execution comprises a plurality of threads of execution, a first one of the threads of execution of the second thread of execution being configured to create a layered structure of the structured document, a second one of the threads of execution of the second thread of execution being configured to create a graphical presentation of the structured document based on the layered structure.
